(19) United States
(12) Patent Application Publication
(10) Pub. No.: US 2022/0266685 A1
(43) Pub. Date: Aug. 25, 2022

(54) HYDROGEN STORAGE SYSTEM

(71) Applicant: FAURECIA SYSTEMES D'ECHAPPEMENT, NANTERRE (FR)

(72) Inventor: Yannick GODARD, BLUSSANS (FR)

(21) Appl. No.: 17/629,444

(22) PCT Filed: Jul. 24, 2020
(86) PCT No.: PCT/EP2020/071034

§ 371 Date: May 3, 2022

(30) Foreign Application Priority Data
Jul. 26, 2019 (FR) FR19 08533

(51) Int. Cl. B60K 15/07; F17C 13/08; B60K 15/03

(52) U.S. Cl. CPC B60K 15/07; F17C 13/084; B60K 15/03006; F17C 2201/0109; F17C 2201/03; F17C 2223/0123; F17C 2221/012; F17C 2270/0184; F17C 2201/056; B60K 2015/03315

(57) ABSTRACT

A hydrogen storage system comprises a substantially cylindrical reservoir having at least one axial neck accommodating a drawing device, a substantially parallelepipedal structure surrounding the reservoir, and a cage supporting the reservoir while gripping around the drawing device. The cage is secured to the structure with at least one interface part that is configured to deform and/or rupture in the event of impact in order that the cage remains secured to the drawing device and transmits little or no force to the drawing device.

### CROSS-REFERENCE TO RELATED APPLICATIONS

This application is the U.S. national phase of PCT/EP2020/071034, which was filed on Jul. 24, 2020, which claims priority to FR 19 08533, filed Jul. 26, 2019.

### FIELD OF THE DISCLOSURE

The disclosure relates to the field of hydrogen storage systems. Such a hydrogen storage system is designed to be integrated on board a light or heavy vehicle, in order to supply the fuel cells.

### BACKGROUND

It is known, to produce a hydrogen storage system, to use a substantially cylindrical reservoir including one or two necks arranged at the axial ends of said cylinder. The reservoir is advantageously made from composite. Said at least one neck conventionally accommodates a drawing device.

In order on the one hand to protect the reservoir and on the other hand to facilitate the integration of the hydrogen storage system on the vehicle, a substantially parallelepipedal structure is provided surrounding and supporting the reservoir. The structure is advantageously made from a metallic material or a composite.

In case of impact, for example following an accident involving the vehicle, the hydrogen storage system should be protected. The structure provides protection for the reservoir.

The drawing device is particularly critical. There is concern for the drawing device being pulled outside the reservoir, if it is subjected to substantial forces. Such releasing of the drawing device can be detrimental.

Therefore, the drawing device should be particularly protected.

### SUMMARY

In order to address this issue, the disclosure proposes to add, to the hydrogen storage system, a cage surrounding the drawing device. The cage is secured to the structure using at least one interface part configured to deform and/or rupture in case of impact. Thus, the cage remains secured to the drawing device and transmits little or no force to the drawing device.

Specific features or embodiments, which may be used alone or in combination, are:

the system further comprises at least one rigid pipe connecting the drawing device to a user, said at least one rigid pipe comprising at least one baffle between the drawing device and the user, able to deform rather than transmitting a force to the drawing device,

the system further comprises a first fastener to fasten at least one pipe to the cage, upstream of said at least one baffle, preferably as close as possible to the drawing device,

the system further comprises a second fastener to fasten at least one pipe to the structure, downstream of said at least one baffle.

the cage is made from aluminum, steel or composite,

the reservoir has a diameter of between 200 and 700 mm and a length of between 500 and 3000 mm.

In a second aspect, the disclosure relates to a vehicle equipped with at least one such hydrogen storage system.

### BRIEF DESCRIPTION OF THE DRAWINGS

The disclosure will be better understood upon reading the following description, provided solely as an example, and in reference to the appended figures, in which:

FIG. 1 shows, in perspective view, a hydrogen storage system,

FIG. 2 shows, in perspective view, a detail of the interface between the drawing device and the structure,

FIG. 3 shows, in perspective view, the detail of FIG. 2 from another point of view,

FIG. 4 shows, in detail, a weakened interface part, and

FIG. 5 shows, in detail, a drawing pipe.

### DETAILED DESCRIPTION

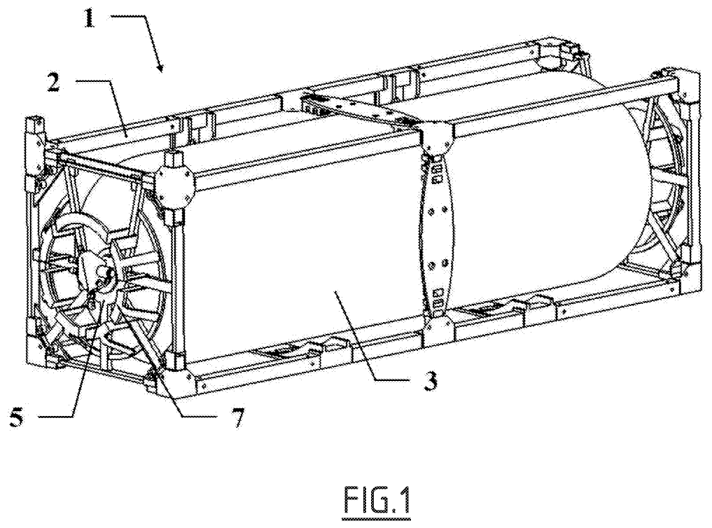

FIG. 1 illustrates a hydrogen storage system 1. This hydrogen storage system 1 comprises a substantially cylindrical reservoir 3. This reservoir 3 includes one or two necks 5 that are advantageously arranged at the axial ends of the cylinder forming the reservoir 3. The reservoir 3 is advantageously made of composite, for example by filament winding. Said at least one neck 5 conventionally accommodates a drawing device 6. A drawing device 6 comprises a base, advantageously made from metal, fastened to the reservoir 3 tightly in the neck 5. In this base, at least one pipe is formed allowing the inside of the reservoir 3 to be connected to the outside so as to perform all the filling operations of the reservoir 3 with hydrogen or drawing operations to use said hydrogen from the reservoir 3. On this at least one pipe and/or base, at least one valve is also arranged allowing the entry or exit of hydrogen to be controlled as well as at least one control and/or safety device, such as a pressure gauge and/or a safety valve.

To protect the reservoir 3, a structure 2 is attached thereto surrounding the reservoir 3. Such a structure 2 thus protects the reservoir 3 by providing it with an outer enclosure. This structure 2, which is advantageously made from metal, provides fastening with the vehicle, thus facilitating the integration of the hydrogen storage system 1 on the vehicle. The structure 2 also has a substantially parallelepipedal shape, which is easier to manipulate, stack and integrate on a vehicle.

The reservoir 3 is advantageously immobilized relative to the structure 2. This is done using a fastener feature that can be varied. As illustrated in FIG. 1, the reservoir 3 can be secured with the structure 2 using the cage 7 secured to the structure 2 and fastening an axial end of the reservoir 3 by gripping the neck 5 and/or the drawing device 6. It is possible to proceed in the same manner for the other axial end. Alternatively, according to another embodiment that is not shown, the reservoir 3 can be immobilized relative to the structure 2, using straps surrounding the reservoir 3 transversely relative to its axis.

In case of impact, for example following an accident involving the vehicle carrying the hydrogen storage system 1, the hydrogen storage system 1 should be protected. The structure 2 provides protection for the reservoir 3.

However, the drawing device 6, due to its arrangement, its contacts, and its inertia, potentially presents certain issues when subjected to impact loads.

Fastening the reservoir 3 using a cage 7 supporting the reservoir 3 by its neck 5 or by the drawing device 6 creates a situation where the drawing device 6 may be torn out by the cage 7 itself, transmitting a force originating from the structure 2 to the drawing device 6.

Due to its difference in inertia, a massive metal device relative to a primarily composite reservoir 3, an excessive differential force applied to the drawing device 6 may cause it to pull out relative to the neck 5.

Such a release of the drawing device 6 may cause damage.

The cage 7 is secured to the structure 2 so as to support the drawing device 6 and the reservoir 3 relative to the structure 2 under normal conditions. However, under significant impact conditions, the cage 7 should transmit little or no force to the drawing device 6 from the structure 2. Therefore, at the assembly of the cage 7 with the structure 2, the cage has at least one interface part 8 configured so as to deform and/or rupture in case of impact. Advantageously, all the junctions between the cage 7 and the structure 2 are fitted with such weakened interface parts 8. Also advantageously, there are a reduced number of junctions, preferably four or three, or even preferably two. Thus, any forces are absorbed owing to the deformation and/or are no longer transmitted owing to the rupture. In case of rupture, the cage 7 remains secured to the drawing device 6. This limits or eliminates the transmission of force to the drawing device 6 coming from the structure 2. In case of impact, this contributes to the drawing device 6 remaining secured to the reservoir 3.

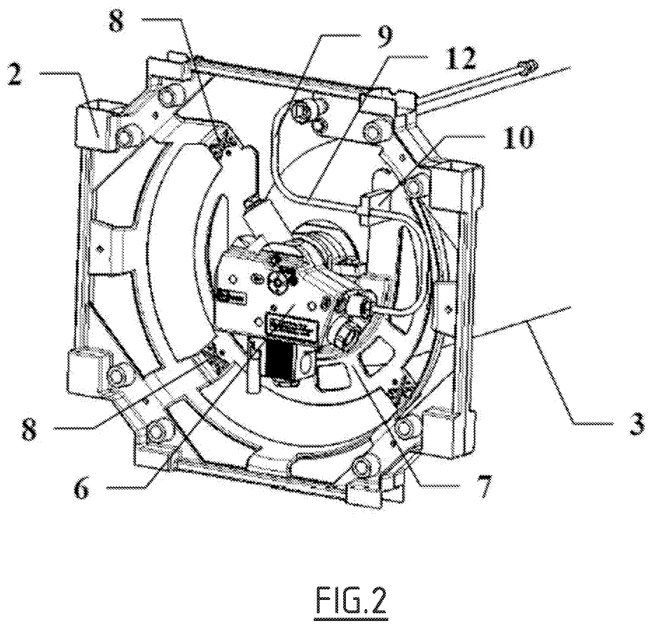

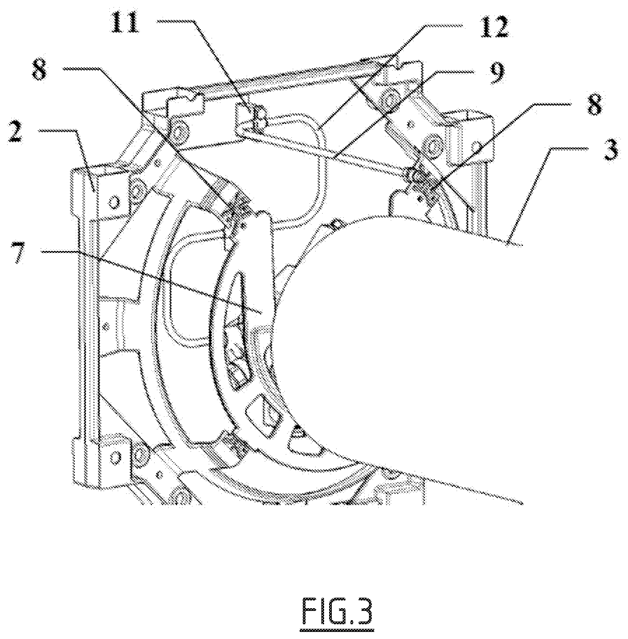

As illustrated in FIGS. 2 and 3, the cage 7 bearings the drawing device 6 and thus the reservoir 3. The cage 7 is secured to the structure 2 via interface parts 8. Here there are four interface parts 8. It may be observed that these interface parts 8 have a reduced cross-section so as to control their strength. The interface parts 8 are also pierced and cut, so as to weaken them as much as needed. The cutting and/or piercing of an interface part 8, in number and shape, is/are determined by the necessary extent of the desired weakening. This measure is determined so as to produce a rupture in case of crash (significant impact following an accident), but to support the reservoir 3 for lesser forces. The design selected for an interface part 8 is then validated by calculations or by an impact test.

In order to create a versatile hydrogen storage system 1, all orientation hypotheses of the impact forces are considered. Thus, the hydrogen storage system 1 according to the disclosure is advantageously able to be integrated according to any orientation on a vehicle.

There is one other cause of force transmission to the drawing device 6. Indeed, the drawing device 6 is, by functional necessity, connected to at least one user outside the hydrogen storage system 1, using at least one pipe 9 distributing the hydrogen to said user or allowing the filling of the reservoir 3. Said at least one pipe 9 is necessarily rigid.

Therefore, in order for said at least one pipe 9 not to exert too much force on the drawing device 6, in case of impact, said pipe 9 comprises at least one baffle 12.

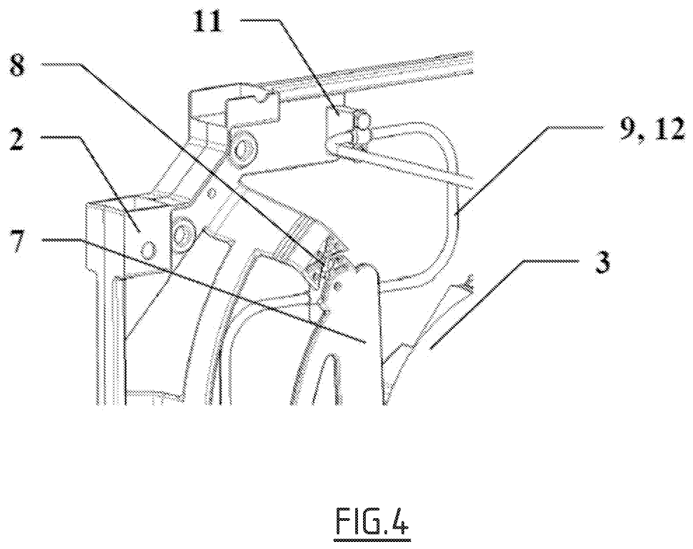

This baffle 12, which is more particularly visible in FIGS. 2-5, is arranged on said at least one pipe 9, between the drawing device 6 and the user outside the device 1. This baffle 12, which is in the shape of a U, a head-to-tail U (S-shaped) or any other form offering a deformation capability of the pipe 9, allows the pipe 9 to be deformed at the baffle 12 while thus preventing the pipe 9 from transmitting a force to the drawing device 6.

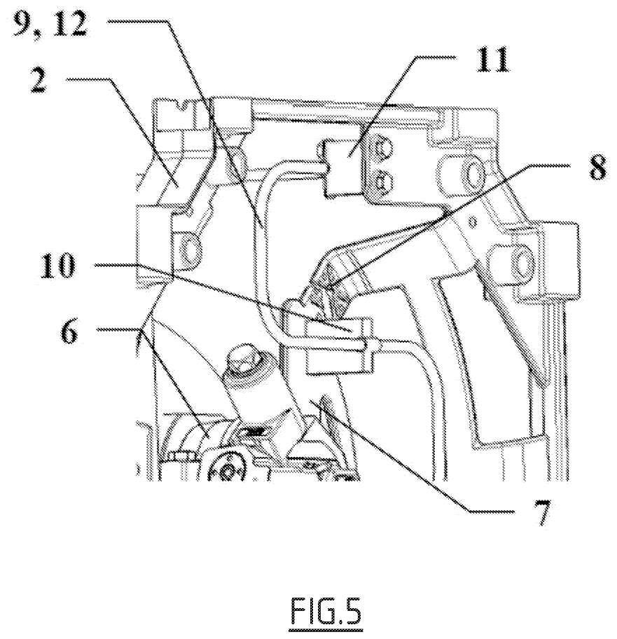

According to another feature, more particularly illustrated in FIGS. 2, 5, the hydrogen storage system 1 further comprises a first fastener 10 to fasten said at least one pipe 9 to the cage 7. This first fastener 10 is advantageously arranged, upstream of said at least one baffle 12, and preferably as close as possible to the drawing device 6.

According to another feature, more particularly illustrated in FIGS. 3, 4, 5, the hydrogen storage system 1 further comprises a second fastener 11 to fasten said at least one pipe 9 to the structure 2, downstream of said at least one baffle 12. Here, upstream and downstream are understood in the direction of spontaneous flow or drawing, or from the reservoir 3 toward the outside.

According to another feature, the cage 7 can be made from any material. Advantageously, the cage 7 is made from aluminum, steel or composite.

According to another feature, the reservoir has a diameter of between 200 and 700 mm and a length of between 500 and 3000 mm. As an example, a storage system for a light vehicle comprises a reservoir having a diameter of 220 mm, a length of 1900 mm, an empty weight of 29.7 kg and can take on 1.67 kg of hydrogen at 700 bars. As an example, a storage system for a heavy vehicle comprises a reservoir having a diameter of 415 mm, a length of 2035 mm, an empty weight of 59.7 kg and can take on 4.7 kg of hydrogen at 350 bars.

The disclosure also relates to a vehicle equipped with at least one hydrogen storage system 1 according to any one of the preceding claims.

The disclosure has been illustrated and described in detail in the drawings and the preceding description. The latter must be considered to be illustrative and provided as an example, and not as limiting the disclosure to this description alone. Many variant embodiments are possible.

### LIST OF REFERENCE SIGNS

1: hydrogen storage system,

2: structure,

3: reservoir,

5: neck,

6: drawing device,

7: cage,

8: interface part,

9: pipe,

10-11: fasteners,

12: baffle.

Although various embodiments have been disclosed, a worker of ordinary skill in this art would recognize that certain modifications would come within the scope of this disclosure. For that reason, the following claims should be studied to determine the true scope and content of this disclosure.

1. A hydrogen storage system, comprising:
a cylindrical reservoir including at least one axial neck accommodating a drawing device;
a parallelepipedal structure surrounding the cylindrical reservoir; and
a cage supporting the cylindrical reservoir while gripping around the drawing device and being secured to the parallelepipedal structure using at least one interface part configured to deform and/or rupture in case of impact so that the cage remains secured to the drawing device and transmits little or no force to the drawing device.

2. The hydrogen storage system according to claim 1, further comprising at least one rigid pipe connecting the drawing device to a user, said at least one rigid pipe comprising at least one baffle between the drawing device and the user, the at least one baffle being able to deform rather than transmitting a force to the drawing device.

3. The hydrogen storage system according to claim 2, further comprising a first fastener to fasten said at least one rigid pipe to the cage, upstream of said at least one baffle.

4. The hydrogen storage system according to claim 2, further comprising a second fastener to fasten said at least one pipe to the parallelepipedal structure, downstream of said at least one baffle.

5. The hydrogen storage system according to claim 1, wherein the cage is made from aluminum, steel, or composite.

6. The hydrogen storage system according to claim 1, wherein the cylindrical reservoir has a diameter of between 200 and 700 mm and a length of between 500 and 3000 mm

7. A vehicle equipped with at least one hydrogen storage system according to claim 1.

8. The hydrogen storage system according to claim 2, wherein the first fastener is arranged as close as possible to the drawing device.
